(19) United States
(12) Patent Application Publication
(10) Pub. No.: US 2015/0100518 A1
(43) Pub. Date: Apr. 9, 2015

(54) ADMINISTERING A CYCLE-BASED COLLARED INVESTMENT OPTION

(71) Applicant: Midland National Life Insurance Company, Sioux Falls, SD (US)

(72) Inventors: William Lowe, West Des Moines, IA (US); Kirk Evans, West Des Moines, IA (US); Brett Agnew, West Des Moines, IA (US)

(21) Appl. No.: 14/508,804

(22) Filed: Oct. 7, 2014

Related U.S. Application Data
(60) Provisional application No. 61/887,844, filed on Oct. 7, 2013.

(51) Int. Cl. G06Q 40/06

(52) U.S. Cl. CPC G06Q 40/06
USPC 705/36 R

(57) ABSTRACT

A system for administering a cycle-based collared investment option may include a processor, memory, and an application stored in memory. The application may be executable by the processor to receive a cycle order. The cycle order may include investment data and a plurality of cycle parameters. The application may further by executable by the processor to send a derivative contract transaction request to a hedge advisor. The derivative contract transaction may be based on the investment data and cycle parameters. The application may further by executable by the processor to receive a daily market value corresponding to a held derivative contract from the hedge advisor. The application may further by executable by the processor to calculate a cycle interim value rate of return. The cycle interim value may be calculated by applying a predetermined formula that accounts for the daily market value received from the hedge advisor.

### CROSS-REFERENCE TO RELATED APPLICATION

The present application claims the priority benefit of U.S. provisional application No. 61/887,844 filed Oct. 7, 2013, the disclosure of which is incorporated herein by reference.

### BACKGROUND

Many modern investment option platforms only offer investments in traditional mutual funds. Mutual funds allow an investor to track mutual fund share prices on a daily basis, but along with any possible return on investment, they pass all of the accompanying risk to the investor. Other forms of investments, such as collared options or offerings that utilize buffers, mitigate the risk of loss in exchange for capping the potential return. Previously existing investment options, however, such as the Structured Capital Strategies^{SM} variable annuity offered by AXA Equitable Life Insurance Company of Charlotte, N.C., and the systems and applications used to administer those options appear to offer investors less than desirable tracking abilities. MetLife, Inc. of New York, N.Y. and Allianz of Munich, Germany offer similar products. In such systems, the daily value is not calculated based on daily market values of held derivatives. Moreover, such options fail to provide investors with sufficient protection in the event that they want to make early withdrawals. Insurance companies and other entities offering investment options need an automated, feasible system and method for effectively administering a hybrid investment vehicle that combines the accessibility of a mutual fund with the protection offered by a collared option, including protection when making early withdrawals.

### SUMMARY

Systems and methods for administering a collared investment option are disclosed. The systems and methods may be implemented over a network and administer a collared investment option in such a way that would not be possible to perform manually.

A system for administering a cycle-based collared investment option may include a processor, memory, and an application stored in memory. The application may be executable by the processor to receive a cycle order. The cycle order may include investment data and a plurality of cycle parameters. The application may further by executable by the processor to send a derivative contract transaction request to a hedge advisor. The derivative contract transaction may be based on the investment data and cycle parameters. The application may further by executable by the processor to receive a daily market value corresponding to a held derivative from the hedge advisor. The application may further by executable by the processor to calculate a cycle interim value rate of return. The cycle interim value rate of return may be calculated by applying a predetermined formula that accounts for the daily market value of the derivative contracts received from the hedge advisor.

In another embodiment, a method of administering a cycle-based collared investment may include receiving a cycle order from a transfer agent. The method may further include executing instructions stored in memory of a computing device. Execution of the instructions by a processor of the computing device may send a derivative contract transaction request to a hedge advisor. Execution of the instructions by the processor may further receive a daily market value corresponding to a held derivative. Execution of the instructions by the processor may further calculate a cycle interim value rate of return. Execution of the instructions by the processor may send the calculated cycle interim value to the transfer agent.

### BRIEF DESCRIPTION OF DRAWINGS

FIG. 1 shows a block diagram of an exemplary system for administering a cycle-based collared investment option.

FIG. 2 shows an exemplary cycle that may be used in accordance with the exemplary system and methods for disclosed herein.

FIG. 3 shows further details regarding an exemplary method for administering a cycle-based collared investment option.

FIG. 4 shows a line graph that conveys an exemplary cycle floor rate and cycle performance ceiling rate.

FIG. 5 shows a chart that conveys an exemplary one-year investment cycle.

FIG. 6 shows a chart that conveys an exemplary six-year investment cycle.

FIG. 7 shows a chart that conveys exemplary cycles and indices that may be utilizes in accordance with the system and methods disclosed herein.

FIG. 8 shows a flow diagram that conveys an exemplary relationship between various exemplary servers that may be utilized to administer the collared investment option.

FIG. 9 shows an exemplary method for administrating a cycle-based collared investment.

FIG. 10 is a block diagram of a computing device for implementing the systems and methods disclosed herein.

### DETAILED DESCRIPTION

Systems and methods for administering a collared investment option are disclosed. The systems and methods may be implemented over a network.

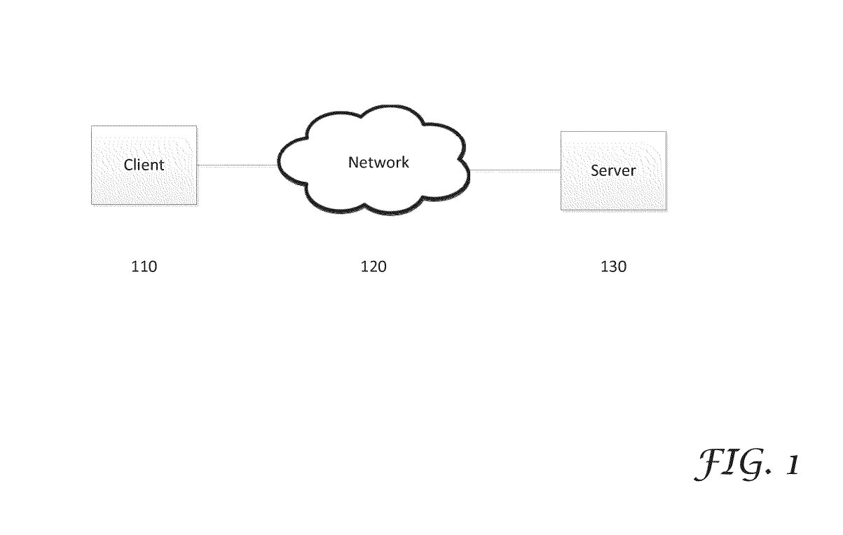

FIG. 1 is a block diagram of an exemplary system for administering a collared investment option. In some embodiments, the system of FIG. 1 may include a client computer 110, network 120, and a server 130. Client computer 110 and server 130 may communicate with one another over network 120. Client computer 110 may be implemented as a desktop, laptop, work station, notebook, tablet computer, smart phones, mobile device or other computing device. Network 120 may be implemented as one or more of a private network, public network, WAN, LAN, an intranet, the Internet, a cellular network or a combination of these networks.

In some embodiments, client computer 110 may perform all or a portion of the functionality described herein, including receiving information about a cycle and calculating a cycle interim value. Server computer 130 may communicate with client computer 110 over network 120. Server computer may perform all or a portion of the functionality discussed herein. In some embodiments, the functionality discussed herein may be distributed between client computer 110 and server computer 130, or may be provided by server computer 130 as a network service for client computer 110. The functionality herein may be performed by one or more applications executing on either the client computer, the server computer, or distributed over both machines as well as additional machines (not illustrated in FIG. 1). Each of client 110 and sever computer 130 are listed as a single block, but it is intended that either couple be implemented using one or more actual machines or logical machines.

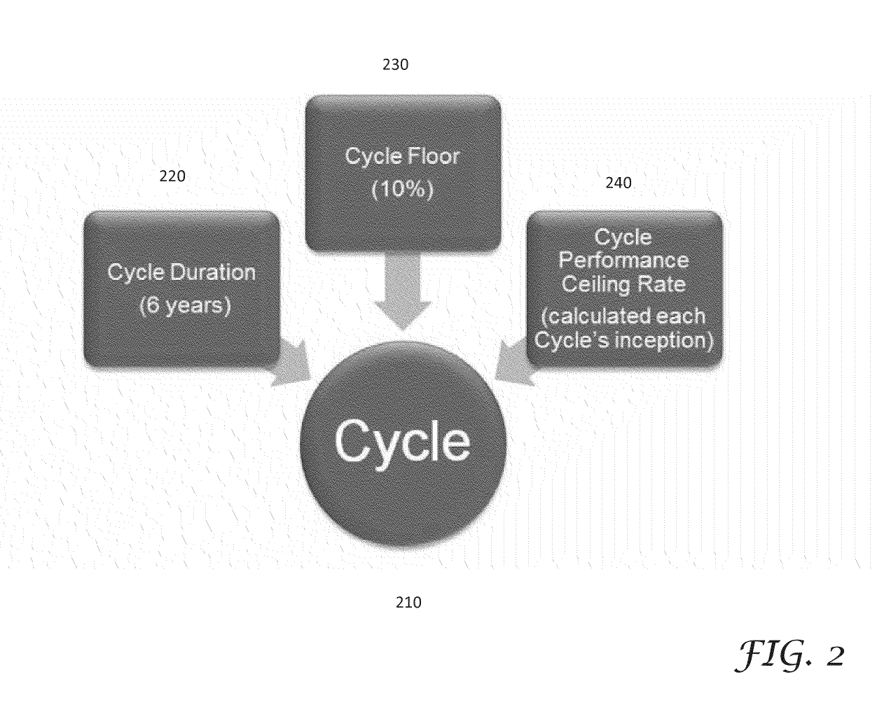

FIG. 2 shows an exemplary cycle that may be used in accordance with the system and methods disclosed herein. In one embodiment, a cycle may be an investment option established by an administrator. The cycle may be associated with a performance index, cycle term, cycle floor rate, and performance ceiling rate offered by the collard investment option. For example, as shown in FIG. 1, a cycle 210 may include one or more parameters, including a cycle term 220, a cycle floor rate 230, and a cycle performance ceiling rate 240.

In an embodiment, the collared investment option may be an insurance contract that provides for a guaranteed payment benefit at a cycle maturity date. The guaranteed payments under the collared investment option may be based on the performance of an index (i.e., not based on the performance of a portfolio of securities). The guaranteed payments may be subject to a maximum referred to as a performance ceiling rate or a proportion thereof for early withdrawals. The payments may likewise be protected by a minimum referred to as the cycle floor rate. Given the cycle floor rate, the collared investment option administered through the systems and methods disclosed herein may provide an opportunity for growth with the upside performance of the index and at the same time may provide protection from the downside performance of the index below a certain rate. Moreover, in some embodiments, the systems and methods disclosed herein may permit a contract holder to make early withdrawals prior to the cycle maturity date based upon a cycle interim value calculated by the system.

The collared investment option may be sold to institutional contract holders that may offer participation in the cycles as investment options in platforms where the only other available investment is traditional mutual funds or separate accounts that invest exclusively in mutual funds. For example, the collared investment option may be offered as an investment choice in a variable annuity or individual retirement account mutual fund platform along with various mutual fund options. As previously mentioned, a mutual fund is generally passive in that most of the investment return and risk of loss are passed to the investor. The cycles used in the collared investment option administered by the systems and methods disclosed herein, on the other hand, may provide participants an opportunity for growth with the upside performance of the index and at the same time may provide protection from the downside performance of the index below a certain rate. In other words, in various exemplary embodiments, the collared investment option may provide for enhanced financial planning by narrowing the spectrum of investment performance between the performance ceiling rate and the cycle floor rate.

### Cycle Term

In some embodiments, the cycle term may be the period from a cycle start date to a cycle maturity date. In some embodiments, a cycle start date may be the cycle business day on which a new cycle is established. For example, in one exemplary embodiment, the cycle start date may be the second cycle business day occurring after the 13th of each month. Each cycle and contract holder may receive a unique identifier for tracking purposes as they are established. In some embodiments, the cycle maturity date may be the cycle business day on which the cycle ends. The cycle term may vary. For example, in one embodiment, the cycle term may be six years. In other embodiments, the cycle term may be other periods of time, such as one, two, three, four, or five year periods.

### Performance Index and Cycle Types

In some embodiments, an index may be used to determine the cycle rate of return for a cycle. In some embodiments, the system may include an index performance rate. The index performance rate may be the percentage change in the value of the related Index from the cycle start date to the cycle maturity date for a given cycle. The index performance rate may be positive or negative. A cycle may not be an actual investment in the underlying Index. For example, in an embodiment, it may be, at cycle maturity, a defined participation in the referenced index's rate of return over the cycle term with a limit on participation for increases in the index (i.e., the cycle's performance ceiling rate) and limits on participation for decreases in the index (i.e., the cycle floor rate). For example, in one embodiment, if the cycle's performance ceiling rate is 20% and the cycle floor rate is −10%, then the contract holder, at cycle maturity, would not lose more than −10% and would not gain more than 20% over the cycle term. For index value changes between a 10% decrease and a 20% increase, the contract holder at cycle maturity would get the actual index performance over the cycle term. In some embodiments, the index performance rate may apply over the entire cycle term; while in others it may apply as an annual performance rate. For example, in one embodiment, the cycle types may be based on the performance of the S&P 500 Price Return Index. In other embodiments, other types of performance indices may be used.

### Cycle Floor Rate

In some embodiments, the cycle floor rate may be the portion of any negative index performance rate that the administrator absorbs in excess of the initial losses the contract holder absorbs on the cycle maturity date for a particular cycle. In such embodiments, any percentage decline in a cycle's index performance rate reduces the contract holder's cycle maturity value. In one embodiment, the cycle floor rate may be −10%. In other embodiments, cycle floor rates may be set at other levels, such as 0%, −5%, −10% or −15%. In some embodiments, the cycle floor rate may apply over the entire cycle term rather than functioning as an annual floor rate.

### Cycle Types

In some embodiments, all cycles having the same index, cycle term, and cycle floor rate may be grouped into common cycle types. In some embodiments, a single cycle type may be offered, while in others multiple cycle types may be offered. For example, in one exemplary embodiment, nine cycle types may be offered. In some embodiments, one cycle type per contract holder may be offered. In other embodiments, multiple cycle types per contract holder may be offered. The offerings may be periodic with advance notice given regarding the upcoming offering, or they may be made according to a predetermined regular schedule, such as monthly.

### Cycle Performance Ceiling Rate

In some embodiments, the system may include a cycle performance ceiling rate. The cycle performance ceiling rate may be the highest cycle rate of return that can be credited on a cycle maturity date. An estimated cycle performance ceiling rate may be determined by the first business day of each month. It may be calculated by the cycle administrator. In some embodiments, the cycle performance ceiling rate may apply over the entire cycle term. The cycle performance ceiling rate may be calculated at the cycle start date. In some embodiments, the system may include a performance ceiling rate notice. The performance ceiling rate notice may be an estimate of the performance ceiling rate and may be transmitted on the first business day of every month. The notice may include an estimated performance ceiling rate for each cycle type available to registered representatives of selling broker-dealers in advance of a cycle start date. In some embodiments, the system may include a cycle minimum performance ceiling rate. The cycle minimum performance ceiling rate may include a threshold whereby a cycle will not be established if the performance ceiling rate would be less than 50% of the applicable initial cycle floor rate. For example, in one exemplary embodiment, a cycle with a cycle floor rate of 15% may not be established unless the cycle performance ceiling rate is 7.5% or greater.

### Cycle Minimum Contribution

In some embodiments, the system may include a cycle minimum contribution. The cycle minimum contribution may be a threshold whereby the application will not generate a new cycle unless the total initial contributions going into the cycle meets or exceeds the threshold. For example, in one exemplary embodiment, the cycle minimum contribution may be $250,000. In such an embodiment, the application will not create a new cycle unless the total initial contributions going into the cycle is at least $250,000.

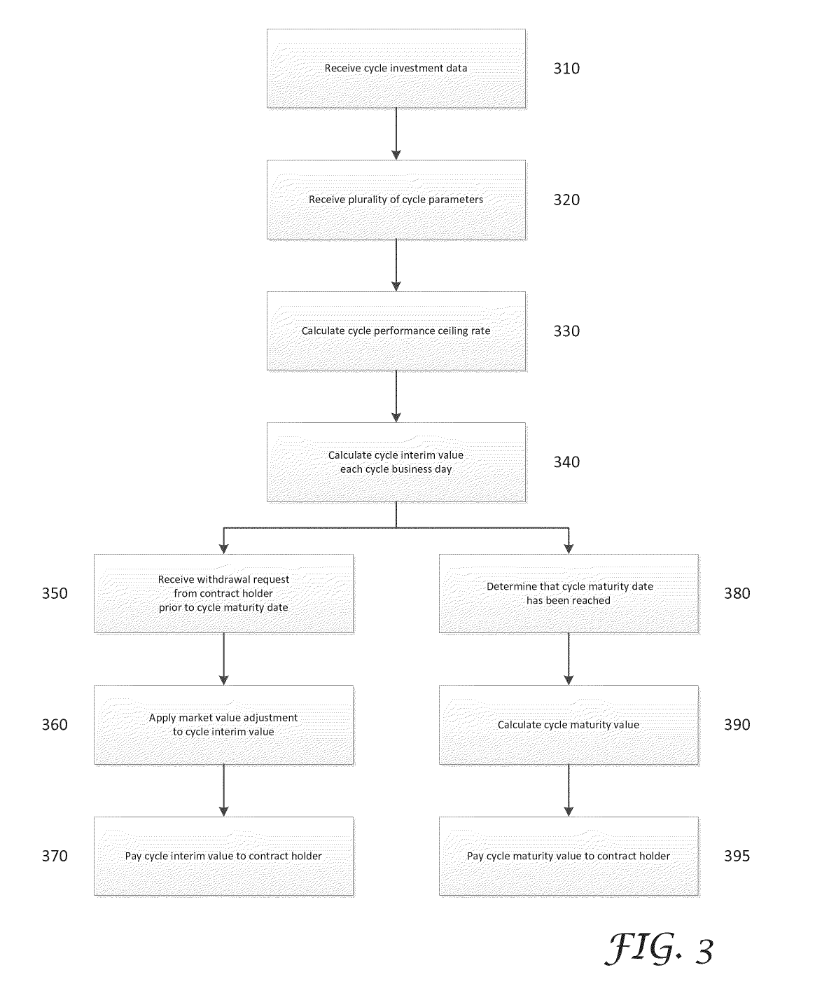

FIG. 3 shows further details regarding an exemplary method for administering a cycle-based collared investment option. In one exemplary embodiment, the method of FIG. 3 may be performed by the system of FIG. 1, which may administer a cycle-based collared investment option and include a processor, memory, and an application stored in memory and executable by the processor. As shown at step 310, when executed by the processor, the application may receive cycle investment data corresponding to an investment within a cycle. The cycle may include a cycle start date. The application may further receive a plurality of cycle parameters at step 320. At step 330, the application may calculate a cycle performance ceiling rate.

The application may further calculate a cycle interim value rate of return each cycle business day at step 340. The cycle interim value rate of return may be based in part on a plurality of market values of derivatives. In some embodiments, the market values of derivatives may be received daily, while in others they may be received according to some other type interval, such as weekly or bi-weekly. The market values of derivatives may be received from a hedge advisor after sending derivative contracts purchase requests to the hedge advisor. The supporting assets tied to each cycle may be held in a non-unitized separate account established under applicable state law. The contract holder's investment performance may not be directly tied to the performance of the supporting assets. Rather, they may be determined by a predetermined formula used to calculate the cycle interim value on a daily basis.

The cycle interim value rate of return may be based on any change in the interest rate environment that occurred between the cycle start date and the cycle business day upon which the contract holder made a withdrawal. The cycle interim value rate of return may take into account an economic value of any change in an index associated with the cycle that occurred between the cycle start date and the cycle business day upon which the contract holder made a withdrawal. The cycle interim value rate of return may consider a maximum loss based on the cycle floor rate. The cycle interim value rate of return may further account for a maximum gain based on a proportional amount of a cycle performance ceiling rate. The proportion amount may be based on the time remaining until a cycle maturity date.

In one exemplary embodiment, calculating the cycle interim value rate of return may include applying an algorithm that accounts for the fair value of fixed instruments based on the then-current interest rate and the time remaining until the cycle maturity date. In another exemplary embodiment, calculating the cycle interim value may include applying an algorithm that, as described above, accounts for the market value of the derivatives required to satisfy an obligation to pay the cycle maturity value based on the cycle performance ceiling rate (i.e., based on the then-current quoted prices of the derivatives). In some embodiments, calculating the cycle interim value rate of return may include applying one or more algorithms that account for some or all of the aforementioned factors.

In an embodiment, a business day may be any day the New York Stock Exchange (NYSE) is open for regular trading and generally ends at 4:00 p.m. Eastern Time (or as of an earlier close of regular trading). In such embodiments, if the Securities and Exchange Commission determines the existence of emergency conditions on any day, and consequently, the NYSE does not open, then that day may not be counted as a business day. In other embodiments, a business day may be defined according to other suitable standards.

A cycle business day may be a business day that all indices underlying available cycles are scheduled to be open and to publish prices. A scheduled holiday for any one index may disqualify that day from being scheduled as a cycle business day for all cycles. In such embodiments, the cycle administrator may mature all cycles on the same day and start all new cycles on a subsequent day. Doing so facilitates the rollover of maturing cycle investments into new cycles. It is possible that due to emergency conditions, an index cannot provide a price on a day that was scheduled to be a cycle business day. In such cases, if the NYSE experiences an emergency close and cannot publish a price, the cycle administrator may not be able to mature or start any cycles for any Index. Additionally, if any exchange other than the NYSE experiences an emergency close and cannot publish a price, the cycle manager may not mature or start cycles for all unaffected indices.

At step 350, the application may receive a withdrawal request from the contract holder prior to the cycle reaching the cycle maturity date. At step 370, the application may pay the cycle interim value to the holder when the holder makes a withdrawal before the cycle maturity date. In some embodiments, as shown at step 360, the application may apply a market value adjustment to the withdrawal. The market value adjustment may apply to all money withdrawn prior to a cycle maturity date including withdrawals for required minimum distributions or withdrawals upon death of the original beneficial owner. Any amounts withdrawn during the cycle may reduce the remaining value in the cycle proportionally based on the ratio of the amount withdrawn to the then current sum of the cycle interim value and total units. The market value adjustment may reflect the change in interest rates, the change in the applicable index's implied volatility, change in the index's level, and the time elapsed since the cycle start date. The market value adjustment may be positive or negative depending on how the various components changed since the cycle start date.

In one exemplary embodiment, if the market value adjustment is positive, the cycle interim value may be the lesser of: the fair value of the fixed instruments plus the market value of the derivatives, and the original investment in the cycle multiplied by the quantity of one plus a pro-rate share of the cycle performance ceiling rate. For example, a cycle with a 1 year cycle term that is 146 days into an investment cycle with a 20% participation limit, the pro-rata share may be equal to the 20% participation limit multiplied by the quantity of 146 days divided by 365 days (20% * 146/365), which results in an 8% cycle interim value. In an embodiment, if the market value adjustment is negative, the cycle interim value may be the greater of the value of the fixed instruments plus the market value of the derivatives and the cycle investment multiplied by (one plus the cycle floor rate). In other embodiments, the cycle interim value may vary to suit the design and goals of the overall system.

If the system determines that the cycle maturity date has been reached, as shown at step 380, the application may further calculate a cycle maturity value based on the cycle maturity date at step 390. Calculating the cycle maturity value may include applying an algorithm that accounts for the cycle investment data and a cycle rate of return. In one embodiment, the application may notify the contract holder that the holder may reallocate the cycle maturity value into another offered cycle or into any other investment option available to the contract holder. In an embodiment, if the index performance rate is positive, the cycle maturity value may equal the lesser of the cycle investment multiplied by (one plus the index performance rate) over the cycle term and the cycle investment multiplied by (one plus the performance ceiling rate) for the cycle. In an embodiment, if the index performance rate is negative, the cycle maturity value may equal to the greater of the cycle investment multiplied by (one plus the index performance rate) over the cycle term and the cycle investment multiplied by (one plus the cycle floor rate). In other embodiments, the cycle maturity value may vary to suit the design and goals of the overall system. The application may then pay the cycle maturity value to the contract holder on the cycle maturity date, as shown at step 395.

The application may track and calculate cycle interim value and maturity values as a function of cycle units. Cycle units may be the number of units sold for a cycle, which may equal the initial investment into the cycle divided by a predetermined price per cycle unit. For example, in one exemplary embodiment, the initial unit value for each cycle may be set at $10. In some embodiments, the number of units for a cycle may be fixed. When a contract holder withdraws from a cycle, the application may provide the funds to pay the contract holder the holder's cycle interim value for the redeemed units. At that point, administrator or an affiliate may own those redeemed units until the cycle maturity date.

In another exemplary embodiment, a method of administering a cycle-based collared investment option may include a step of receiving a cycle order. The cycle order may be received directly from a contract holder or it may be received from a transfer agent or other third-party. The method may further include sending a derivative contract transaction request to a hedge advisor. The method may further include receiving a daily market value corresponding to a held derivative contract. The method may include calculating a cycle interim value as described above. The method may further include sending the calculated cycle interim value to the contract holder, transfer agent, or other third-party.

In some embodiments, the system may include a transfer agent application stored in memory and executable by a processor. The application may be stored in memory at a transfer agent server. The transfer agent application may track unit ownership at the contract holder level. The transfer application may also manage unit transactions and changes in ownership over the life of each cycle. In such embodiments, the transfer application may be executable to perform a step of receiving a cycle order from a contract holder. The application may send a total cycle transaction amount to an administrator. The application may further receive a cycle interim value from the administrator. In one embodiment, the cycle interim value may have been calculated by an administrator system. In another embodiment, the cycle interim value may have been calculated by a suitable third party system. In yet another embodiment, the transfer application may calculate the cycle interim value itself. The application may further record a cycle position associated with the contract holder.

In some embodiments, the exemplary systems and method for administering a cycle-based collared investment option disclosed herein may allow for hedging risk. In such embodiments, the system may include an application that receives a derivative contract transaction request from an administrator. The application may complete a derivative contract transaction. The application may also include sending a daily market value associated with a derivative contract to the administrator application.

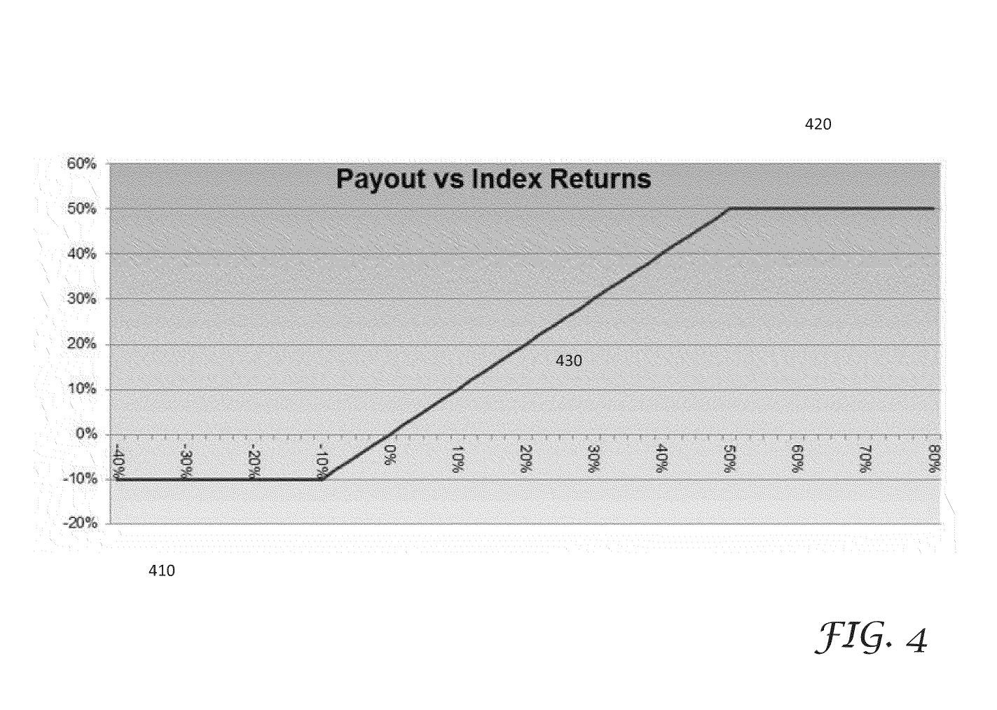

FIG. 4 shows a line graph that conveys an exemplary cycle floor rate and cycle performance ceiling rate. As shown in one exemplary embodiment, the cycle floor rate may be set at negative ten percent. In FIG. 4, the cycle floor rate is represented by the zero slope line extending from an index return of −40% to an index return of −10%. The zero slope indicates that no matter how poorly the index performs after its rate of return has dropped below −10%, the payout, or loss in this exemplary embodiment, will never drop below −10%. The cycle performance ceiling rate is represented by the zero slope line 420 extending from an index return of 50% to an index return of 80%. The zero slope indicates that no matter how well the index performs after its rate of return has reached 50%, the payout will never exceed 50%. Line 430, which has a slope of +1 and extends between the ceiling floor rate and the cycle performance ceiling, represents the payout percentage that is variable according to the index returns. The relationship illustrated by FIG. 4 is sometimes referred to as a “collar” in the art. Collared investment options represent conservative investment options compared to some other forms of investments. They place a cap on the potential payout that the investment may produce, but they also minimize risk by capping the amount of loss that the investment may produce.

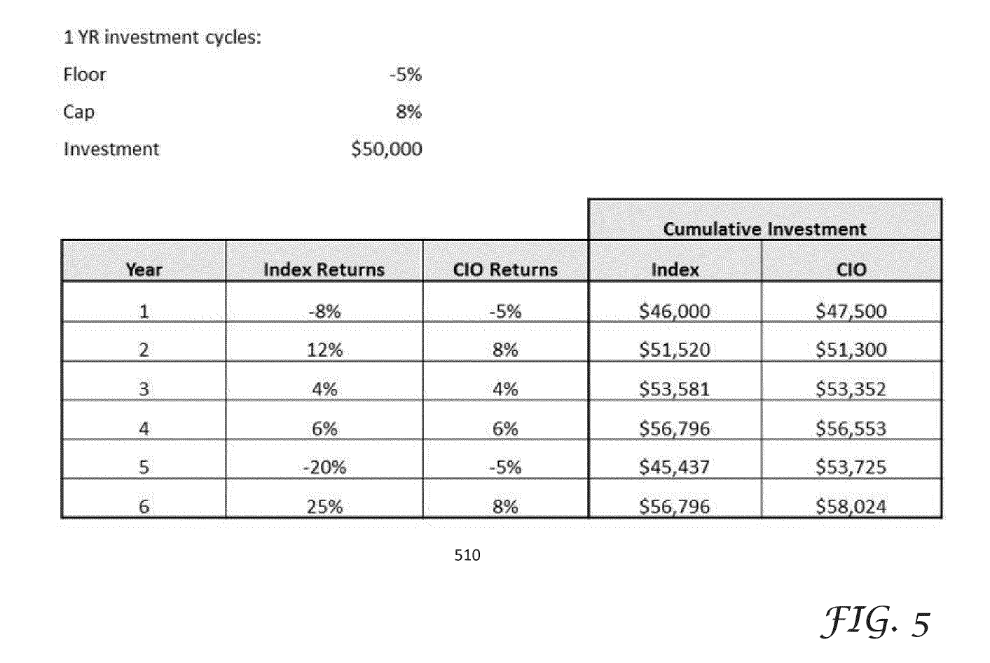

FIG. 5 shows a chart 510 that conveys an exemplary one-year cycle term. As shown in an exemplary embodiment, the cycle floor rate may be −5%, while the cycle performance ceiling rate may be 8%. The investment may be $50,000. As illustrated in the chart, the collared investment option returned 8% in the second cycle year because the index returned 12% and the cycle performance ceiling rate is 8%. In the sixth cycle year, the collared investment option still only returned 8% even though the index returned 25% as opposed to the 12% it returned in the second cycle year. The collared investment option did not result in a greater return in the sixth year because the cycle performance ceiling rate of 8% prevented the returns from increasing any further. Conversely, in the first cycle year, the collared investment option resulted in a loss of 5% because the index return was −8% and the cycle floor rate is −5%. In the fifth cycle year, the collar investment option still only resulted in a loss of 5% even though the index return was −20% as compared to only −8% in the first cycle year. The collared investment option did not result in a greater loss in the fifth year because the cycle floor rate of −5% prevented the loss from increasing any further.

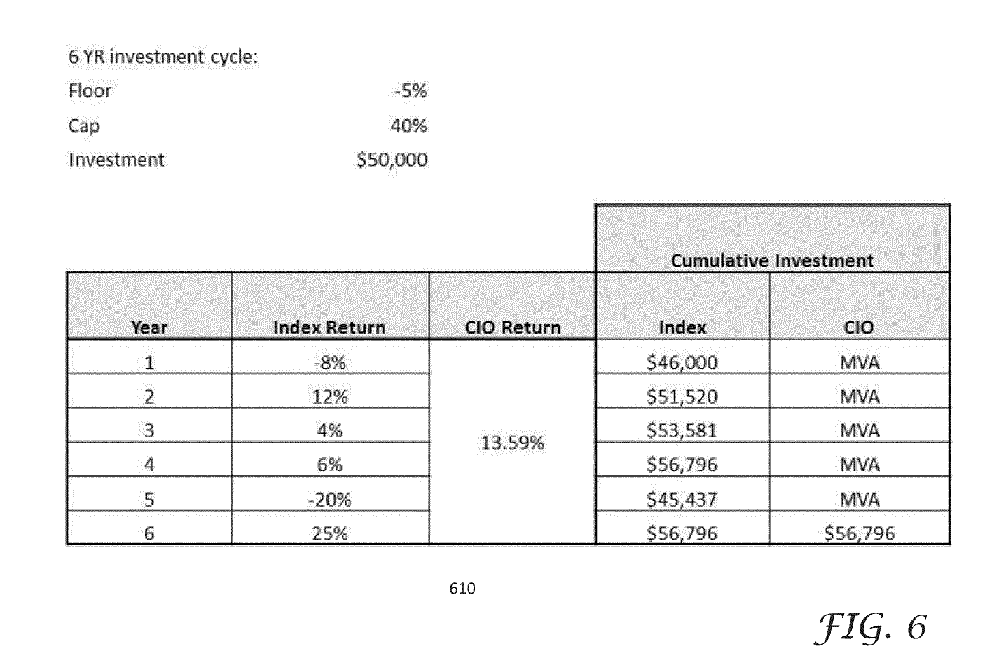

FIG. 6 shows a chart 610 that conveys an exemplary six-year cycle term. As shown in an exemplary embodiment, the cycle floor rate may be −5%, while the cycle performance ceiling rate may be 40%. The investment may be $50,000. Unlike the embodiment shown in FIG. 5, the exemplary collared investment option shown in FIG. 6 returns a single rate over the six-year cycle term. The value of the collared investment during any given cycle year is determined by one or more market value adjustments.

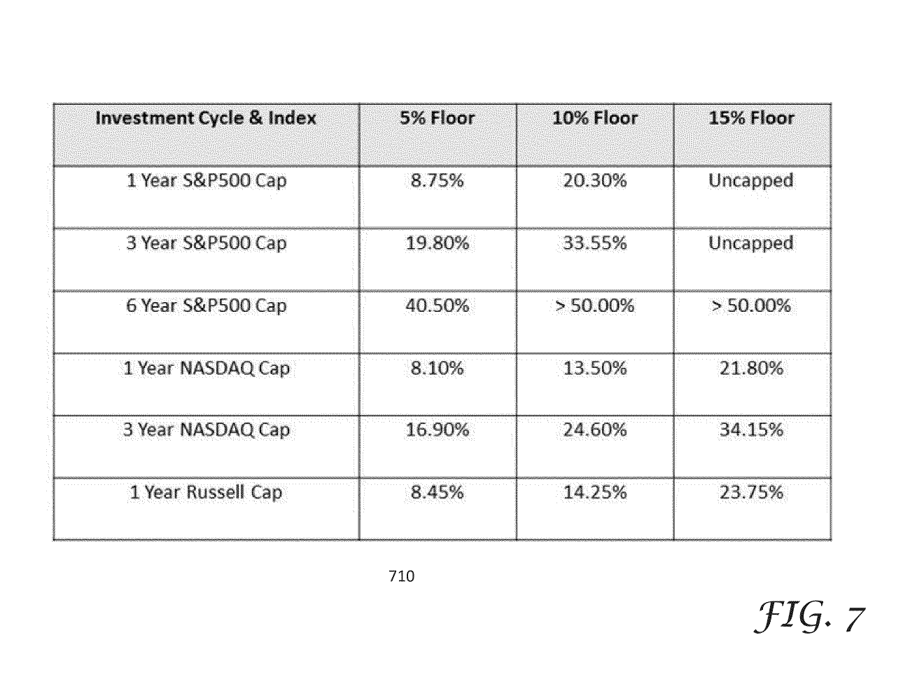

FIG. 7 shows a chart 710 that conveys exemplary cycles and indices that may be utilizes in accordance with the system and methods disclosed herein. In various embodiments, the cycle index may be the S&P 500 and the cycle term may be one, three, or six years in length. In another embodiment, the cycle index may be the NASDAQ and the cycle term may be one or three years in duration. In yet another embodiment, the index may be a Russell index with a one year cycle term.

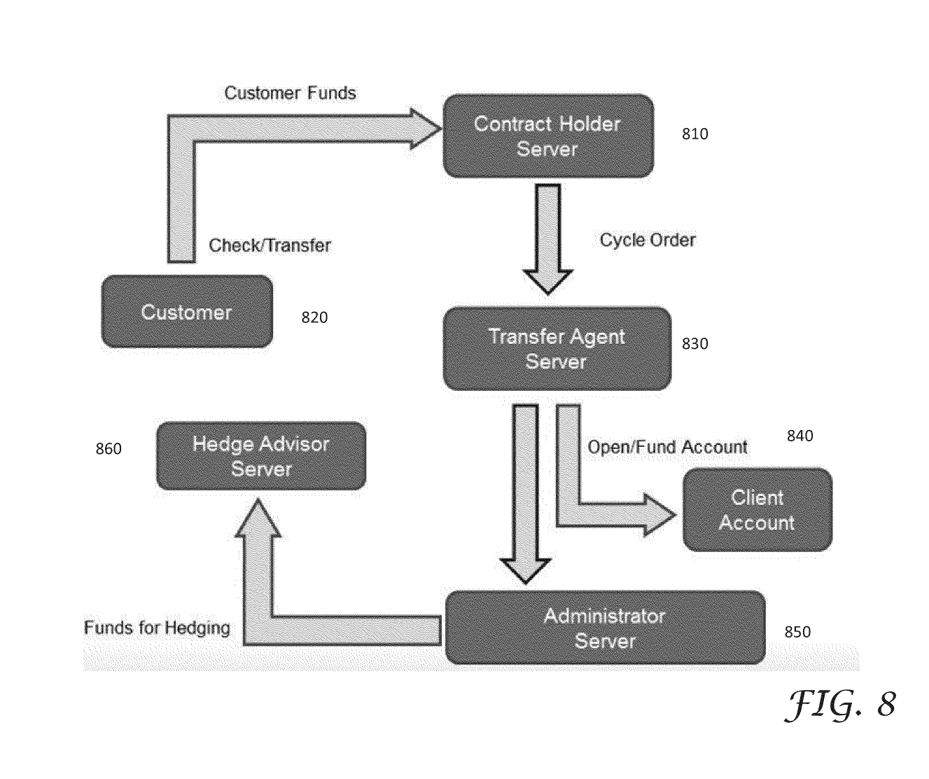

FIG. 8 shows a flow diagram that conveys an exemplary relationship between various exemplary servers that may be utilized to administer the collared investment option in some embodiments. In such embodiments, a contract holder server 810 may receive contract holder funds from a customer 820. The contract holder server 810 may generate a cycle order based on the contract holder funds and other parameters. The contract holder server 810 may transmit the cycle order to a transfer agent server 830. Upon receiving the cycle order, the transfer agent server 830 may generate a client account 840 associated with the cycle order. The transfer agent server 830 may also transmit the cycle order to an administrator server 850. The administrator server 850 may transmit funds for hedging to a hedge advisor server 860. Although not shown in FIG. 8, the hedge advisor server may transmit to the administrator server 850 the market value of derivative contracts purchased with the funds received from the administrator server. The administrator server may then calculate a daily cycle interim value rate of return based on the market values. The administrator server 850 may then transmit the cycle interim value to the transfer agent server 830. The transfer agent server 830 may update the client account 840 based on the newly calculated cycle interim value.

The customer and/or contract holder may then review the updated account to access information about the cycle interim value at the close of the previous cycle business day. The customer and/or contract holder may conduct the review through a graphical interface displayed at a client device, such as the client computer 110 of FIG. 1. The graphical interface may be displayed by an application stored in memory and executable by a processor of the client device. In various embodiments, the system may include some or all of the servers shown in FIG. 8. In other embodiments, other servers may likewise be utilized. Moreover, in various embodiments, the actions performed by one server may be performed by any other server. For example, in some embodiments, the hedge advisor server 860 may transmit the derivative contract market values to the transfer agent server 830 rather than the administrator server 850. The foregoing functionalities may performed by an application stored in memory and executable by a processor in each of the respective servers.

Similarly, the transfer agent, as opposed to the administrator server, may calculate the cycle interim value in some embodiments. The cycle start date and cycle maturity date may be managed by an executable application stored in memory at the transfer agent server or an executable application stored in memory at the contract holder server. Other customer level details and the administration of the collared investment option rules governing funding into the collared investment option, redeeming out of the collared investment option, and renewing cycle allocations may be managed by an executable application stored in memory at the transfer agent server or an executable application stored in memory at the contract holder server. For example, the administration of the collared investment option rules may be managed by an executable application stored in memory at a server maintained by the variable annuity or mutual fund from which the collared investment option contributions initiate. The cycle start dates, the management of the cycles, the valuation of cycle interim values, and the determination of cycle maturity value, may be managed an executable application stored in memory at the administrator server.

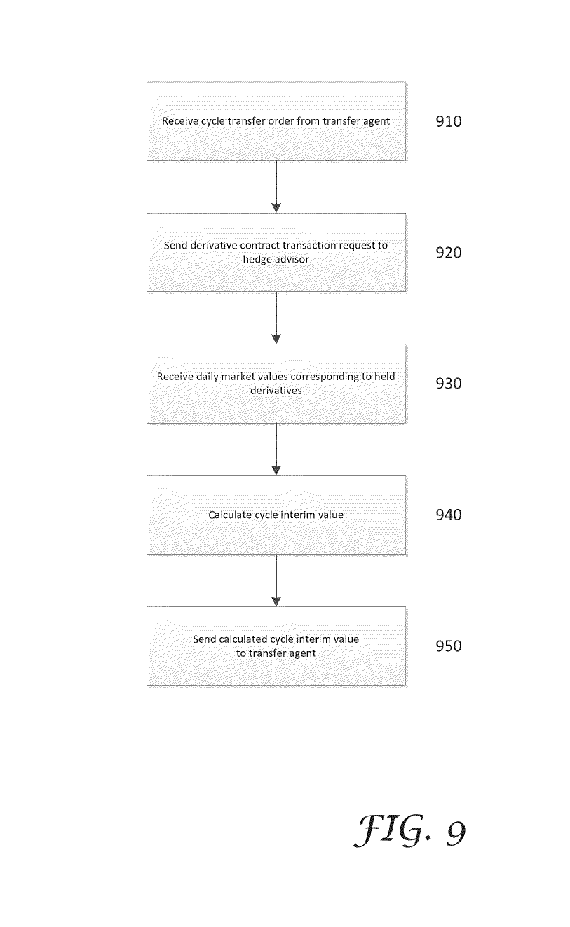

FIG. 9 shows an exemplary method for administrating a cycle-based collared investment. The method of FIG. 9 may be performed by the system of FIG. 1. In an embodiment, the method may include receiving a cycle order from a transfer agent at step 910. The method may further include executing instructions stored in memory of a computing device. Execution of the instructions by a processor of the computing device may send a derivative contract transaction request to a hedge advisor at step 920. At step 930, execution of the instructions by the processor may further receive a daily market value corresponding to a held derivative. Execution of the instructions by the processor may further calculate a cycle interim value rate of return at step 940. At step 950, execution of the instructions by the processor may send the calculated cycle interim value to the transfer agent.

In yet another embodiment, a method of administering a cycle-based collared investment option may include a step of receiving a cycle order from a contract holder. The method may also include a step of executing instructions stored in memory of a computing device, wherein execution of the instructions by a processor of the computing device sends a total cycle transaction amount to an administrator. Execution of the instructions by a processor may further receive a cycle interim value from the administrator. The cycle interim value rate of return may have been calculated by the administrator. Execution of the instructions by a processor may also record a cycle position associated with the contract holder.

In another embodiment, a method of administering a cycle-based collared investment option may include executing instructions stored in memory of a computing device, wherein execution of the instructions by a processor of the computing device receives a derivative transaction request from an administrator. Execution of the instructions by a processor may further complete a derivative contract transaction. Execution of the instructions by a processor may also send a market value associated with a derivative contract to the administrator.

In some embodiments, calculating the cycle interim value rate of return may include applying an algorithm that accounts for the fair value of fixed instruments based on the then-current interest rate and the time remaining until the cycle maturity date. In some embodiments, calculating the cycle interim value rate of return may include executing an algorithm that accounts for the market value of the derivatives required to satisfy the obligations associated with paying the cycle maturity value based on the cycle performance ceiling rate. In some embodiments, held derivative contracts may be option contracts.

In one embodiment, the assets supporting the insurance contract may be held in a non-unitized separate account. For each cycle, the administrator server may transmit purchase and/or sell instructions regarding a combination of fixed instruments and derivatives to a seller and/or buyer of such fixed instruments and derivatives. The purchased combination of fixed instruments and derivatives may support the cycle's guaranteed payment benefit on the cycle maturity date. In some embodiments, the derivative instruments, in combination with the fixed instruments, may be held in the appropriate amounts and may have the appropriate maturity, strike, and referenced index to cover each cycle's guaranteed payment benefit on the cycle maturity date without rebalancing. In some embodiments, the system and methods described herein may be used to implement an administer an insurance option that does not comply with standard non-forfeiture law. Rather, the guaranteed payment benefits provided under the insurance contract may be supported by assets held in a non-unitized separate account.

In one embodiment, the system may calculate the reserves necessary to support the insurance option by projecting the cycle interim value forward at a valuation interest rate. In some embodiments, the valuation interest may also serve as the discount rate. Accordingly, in such embodiments, the reserve may be equal to the cycle interim value. In an embodiment, the statutory reserve on each valuation date may be the cycle interim value.

In some embodiments, the insurance option, along with the assets supporting the insurance contract in a non-unitized separate account, may be modeled as a line of business during cash flow testing, which may form the analytical basis for an accompanying actuarial opinion. In forming a reserve opinion, the assets and reserves of the administrator employing the system and methods described herein may be aggregated such that the results of the cash flow testing for a lone of business with redundant reserves are aggregated with the results for a line of business whose reserves are deficient.

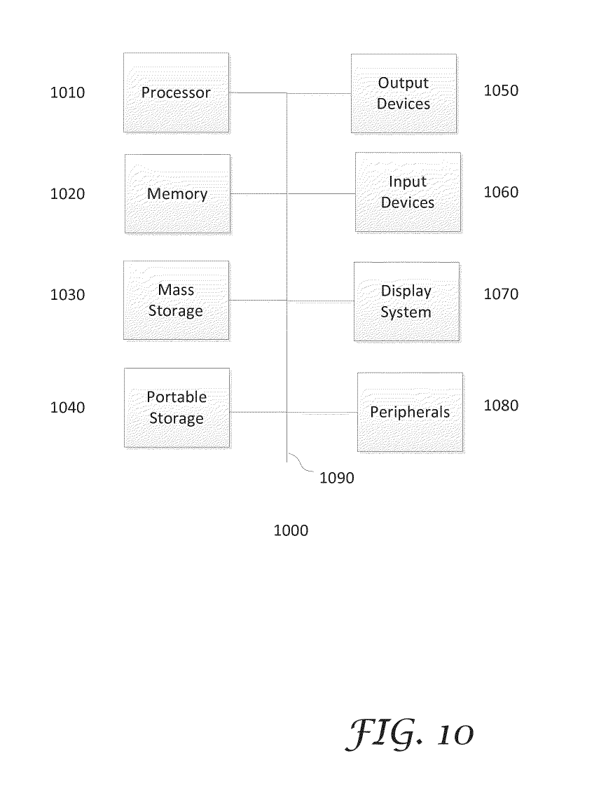

FIG. 10 is a block diagram of a device for implementing the systems and methods disclosed herein. System 1000 of FIG. 10 may be implemented in the contexts of the likes of client computer 110 and server computer 130. The computing system 1000 of FIG. 10 includes one or more processors 1010 and memory 1020. Main memory 1020 may store, in part, instructions and data for execution by processor 1010. Main memory can store the executable code when in operation. The system 1000 of FIG. 10 further includes storage, which may include mass storage 1030 and portable storage 1040, output devices 1050, user input devices 1060, a display system 1070, and peripheral devices 1080. Although not shown in FIG. 10, system 1000 may also optionally include an antenna.

The components shown in FIG. 10 are depicted as being connected via a single bus 1090. However, the components may be connected through one or more data transport means. For example, processor unit 1010 and main memory 1020 may be connected via a local microprocessor bus, and the storage 1030, peripheral device(s) 1080 and display system 1070 may be connected via one or more input/output (I/O) buses. Storage device 1030, which may include mass storage implemented with a magnetic disk drive or an optical disk drive, may be a non-volatile storage device for storing data and instructions for use by processor unit 1010. Storage device 1030 can store the system software for implementing embodiments of the present invention for purposes of loading that software into main memory 1010.

Portable storage device of storage 1030 operates in conjunction with a portable non-volatile storage medium, such as a floppy disk, compact disk or Digital video disc, to input and output data and code to and from the computer system 1000 of FIG. 10. The system software for implementing embodiments of the present invention may be stored on such a portable medium and input to the computer system 1000 via the portable storage device. As described above, system 1000 may also include one or more antenna. Those antenna may include one or more antennas for communicating wirelessly with another device. They may be used, for example, to communicate wirelessly via Wi-Fi, Bluetooth, with a cellular network, or with other wireless protocols and systems. The one or more antennas may be controlled by a processor 1010, which may include a controller, to transmit and receive wireless signals. For example, processor 1010 execute programs stored in memory 1020 to control one or more antenna transmit a wireless signal to a cellular network and receive a wireless signal from a cellular network.

The system 1000 as shown in FIG. 10 includes output devices 1050 and input device 1060. Examples of suitable output devices include speakers, printers, network interfaces, and monitors. Input devices 1060 may include a touch screen, microphone, accelerometers, a camera, and other device. Input devices 1060 may include an alpha-numeric keypad, such as a keyboard, for inputting alpha-numeric and other information, or a pointing device, such as a mouse, a trackball, stylus, or cursor direction keys. Display system 1070 may include a liquid crystal display (LCD), LED display, or other suitable display device. Display system 1070 receives textual and graphical information, and processes the information for output to the display device. Peripherals 1080 may include any type of computer support device to add additional functionality to the computer system. For example, peripheral device(s) 1080 may include a modem or a router.

The components contained in the computer system 1000 of FIG. 10 are those typically found in computing system, such as but not limited to a desk top computer, lap top computer, notebook computer, net book computer, tablet computer, smart phone, personal data assistant (PDA), or other computer that may be suitable for use with embodiments of the present invention and are intended to represent a broad category of such computer components that are well known in the art. Thus, the computer system 1000 of FIG. 10 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

As noted above, system 1000 may also include one or more antennas or other wireless communication mechanisms for communicating over a wireless network such as a WiFi network, cellular network, or other wireless communications network.

Additional information on the methods and systems disclosed herein is disclosed at Appendix A, including an exemplary insurance contract and an exemplary actuarial memorandum that may be utilized in conjunction with the same.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A computing device that automatically administers a cycle-based collared investment option, comprising:
a processor;
memory; and
an application stored in memory and executable by the processor to:
receive a cycle order, the cycle order including investment data and a plurality of cycle parameters;
send a derivative contract transaction request to a hedge advisor;
receive a daily market value corresponding to a held derivative contract from the hedge advisor; and
calculate a cycle interim value.

2. The computing device of claim 1, wherein the cycle interim value rate of return is based on the following factors:
any change in the interest rate environment that occurred between the cycle start date and the cycle business day upon which the holder made the withdrawal;
an economic value of any change in the index of the cycle that occurred between the cycle start date and the cycle business day upon which the contract holder made the withdrawal;
a maximum loss based on the cycle floor rate; and
a maximum gain based on a proportional amount of the cycle performance ceiling rate, wherein the proportion amount is based on the time remaining until the cycle maturity date.

3. The computing device of claim 1, wherein calculating the cycle interim value includes applying an algorithm that accounts for the fair value of fixed instruments based on the then-current interest rate and the time remaining until the cycle maturity date.

4. The computing device of claim 1, wherein calculating the cycle interim value includes executing an algorithm that accounts for the market value of the derivatives required to satisfy the obligations associating with paying the cycle maturity value based on the cycle performance ceiling rate.

5. The computing device of claim 1, wherein the held derivative contract is an option contract.

6. A computing device that automatically administers a cycle-based collared investment option, comprising:
a processor;
memory; and
an application stored in memory and executable by the processor to:
receive cycle investment data;
receive a plurality of cycle parameters;
calculate a cycle performance ceiling rate;
calculate a cycle interim value rate of return each cycle business day;
pay the cycle interim value to the contract holder when the contract holder makes a withdrawal before the cycle maturity date;
calculate a cycle maturity value on the cycle maturity date; and
pay the cycle maturity value to a contract holder on the cycle maturity date.

7. The computing device of claim 6, wherein calculating the cycle maturity value includes applying an algorithm that accounts for the cycle investment data and a cycle rate of return.

8. The computing device of claim 6, wherein the cycle interim value rate of return is based on the following factors:
any change in the interest rate environment that occurred between the cycle start date and the cycle business day upon which the holder made the withdrawal;
an economic value of any change in the index of the cycle that occurred between the cycle start date and the cycle business day upon which the holder made the withdrawal; and
a maximum loss based on the cycle floor rate; and
a maximum gain based on a proportional amount of the cycle ceiling rate, wherein the proportion amount is based on the time remaining until the cycle maturity date.

9. The computing device of claim 6, wherein calculating the cycle interim value rate of return includes applying an algorithm that accounts for the fair value of fixed instruments based on the then-current interest rate and the time remaining until the cycle maturity date.

10. The computing device of claim 7, wherein calculating the cycle interim value rate of return includes executing an algorithm that accounts for the market value of the derivatives required to satisfy the obligation associated with paying the cycle maturity value based on the cycle performance ceiling rate.

11. The computing device of claim 1, wherein the derivative contracts include option contracts.

12. A method of administering a cycle-based collared investment option, comprising:
receiving at a computing device cycle order from a transfer agent; and
executing instructions stored in memory of the computing device, wherein execution of the instructions by a processor of the computing device:
sends a derivative contract transaction request to a hedge advisor,
receives a daily market value corresponding to a held derivative contract,
calculates a cycle interim value rate of return, and
sends the calculated cycle interim value to the transfer agent.

13. The method of claim 11, wherein calculating the cycle interim value rate of return includes applying an algorithm that accounts for the fair value of fixed instruments based on the then-current interest rate and the time remaining until the cycle maturity date.

14. The method of claim 11, wherein calculating the cycle interim value rate of return includes executing an algorithm that accounts for the market value of the derivatives required to satisfy the obligations associated with paying the cycle maturity value based on the cycle ceiling rate.

15. The method of claim 11, wherein the held derivative is an option contract.

16. The method of claim 11, further comprising:
receiving a cycle order from a contract holder at a computing device; and
executing instructions stored in memory of the computing device, wherein execution of the instructions by a processor of the computing device:
sends a total cycle transaction amount to an administrator,
receives a cycle interim value from the administrator, the cycle interim value rate of return having been calculated by the administrator, and
records a cycle position associated with the contract holder.

17. The method of claim 16, wherein the cycle interim value rate of return is calculated by applying an algorithm that accounts for the fair value of fixed instruments based on the then-current interest rate and the time remaining until the cycle maturity date.

18. The method of claim 16, wherein the cycle interim value is calculated by applying an algorithm that accounts for the market value of the derivative contracts required to satisfy the obligations associated with paying the cycle maturity value based on the cycle performance ceiling rate.

19. A method of administering a cycle-based collared investment option, comprising:
receiving a cycle order at a computing device; and
executing instructions stored in memory of the computing device, wherein execution of the instructions by a processor of the computing device:
sends a derivative contract transaction request to a hedge advisor,
receives a daily market value corresponding to a held derivative contract,
calculates a cycle interim value, and
calculates a quantity of reserves necessary to support the insurance option by projecting the cycle interim value forward at a valuation interest rate.

20. The method of claim 19, wherein the valuation interest rate is also the discount rate.

21. The method of claim 19, wherein the quantity of required reserves is equal to the cycle interim value.
